(19) United States
(12) Patent Application Publication
(10) Pub. No.: US 2026/0306349 A1
(43) Pub. Date: Oct. 8, 2026

(54) SEXUAL STIMULATION DEVICE

(71) Applicant: HYTTO PTE. LTD., Singapore (SG)

(72) Inventors: Zhiwen WU, Guangzhou (CN); Dan LIU, Guangzhou (CN); Jilin QIU, Guangzhou (CN)

(21) Appl. No.: 19/707,585

(22) Filed: Jun. 15, 2026

Related U.S. Application Data
(63) Continuation-in-part of application No. 19/347,627, filed on Oct. 1, 2025.
Application No. 19/347,627 is a continuation-in-part of application No. 18/974,075, filed on Dec. 9, 2024, now Pat. No. 12,447,097.
Application No. 18/974,075 is a continuation-in-part of application No. 18/744,856, filed on Jun. 17, 2024, now Pat. No. 12,324,784.
Application No. 18/744,856 is a continuation-in-part of application No. 18/400,273, filed on Dec. 29, 2023, now Pat. No. 12,036,172.

(51) Int. Cl. A61H 19/00

(52) U.S. Cl. CPC A61H 19/44

(57) ABSTRACT

Disclosed is a sexual stimulation device. The device includes a housing, a drive mechanism disposed in the housing, an active deformable element mechanically coupled to the drive mechanism and configured to deform in response thereto to generate a pressure change, and a passive reconfigurable element configured to stimulate at least part of a sensitive area of a user. The active deformable element, the passive reconfigurable element, and the housing cooperatively define a sealed space such that deformation of the active deformable element generates the pressure change within the substantially sealed space, the pressure change being transmitted through the substantially sealed space to thereby passively reconfigure the passive reconfigurable element to provide stimulation to the at least part of the sensitive area.

### CROSS-REFERENCE TO RELATED APPLICATIONS

This application is a continuation in Part of U.S. application No. 19/347,627, filed Oct. 1, 2025, which is a continuation-in-part of U.S. application No. 18/974,075, filed Dec. 9, 2024, and issued as U.S. Patent No. 12,447,097 on Oct. 21, 2025, which is a continuation-in-part of U.S. application No. 18/744,856, filed Jun. 17, 2024, and issued as U.S. Patent No. 12,324,784 on Jun. 10, 2025, which is a continuation-in-part of U.S. application No. 18/400,273, filed on Dec. 29, 2023, and issued as U.S. Patent No. 12,036,172 on Jul. 16, 2024. Each of the above applications is hereby incorporated by reference in its entirety.

### TECHNICAL FIELD

The present disclosure relates to stimulation devices and, more specifically, to stimulation devices with closed-system pressure balancing.

### BACKGROUND

Sexual stimulation devices are devices that are used to stimulate the erogenous zones of users by the application of various sensations in the form of vibration, reciprocation, rotation, suction, etc. Conventional suction-type sexual stimulation devices generally generate pressure stimulation by pumping air into and out of an airtight space through an electric air pump assembly. Existing solutions commonly employ a diaphragm pump or a piston pump in combination with valves, air conduits, and sealed chambers to achieve airflow transmission and pressure regulation.

However, existing suction-type sexual stimulation devices usually require independently arranged air pump assemblies together with multiple valves, conduits, and connection structures, resulting in relatively complicated structures, a large number of components, and increased occupied space, which is unfavorable for product miniaturization and integration. In addition, diaphragm pumps and piston pumps tend to generate noticeable mechanical noise and vibration during operation, thereby adversely affecting user privacy and comfort.

### SUMMARY

A sexual stimulation device includes a housing, a drive unit at least partially disposed within the housing, a first stimulation element directly or indirectly coupled with the drive unit and driven by the drive unit to generate a movement, the movement configured to stimulate a sensitive area of a human body, an active stretchable seal configured to dynamically seal a relative movement part between the housing and the first stimulation element or the drive unit with respect to the housing, and to deform with the movement of the first stimulation element, and a passive stretchable element. The passive stretchable element is configured to deform passively due to the deformation of the active stretchable seal, thereby resulting in the dynamic balance of air pressure in an enclosed space at least defined by the passive stretchable element and the active stretchable seal.

A sexual stimulation device includes a housing, a drive unit at least partially disposed within the housing, a first stimulation element directly or indirectly coupled with the drive unit and driven by the drive unit to generate a movement, the movement configured to stimulate a sensitive area of a human body, and a removable attachment having a second stimulation element coupled with the first stimulation element and configured to reciprocate with a reciprocating movement of the first stimulation element.

A sexual stimulation device includes an active stretchable seal disposed at a first end of a body portion, the active stretchable seal creating pressure as it moves. A drive unit moves the active stretchable seal. A passive stretchable element is disposed at a second end of the body portion. A pressure pathway carries the pressure created by the active stretchable seal to the passive stretchable element such that the total pressure within the active stretchable seal, passive stretchable element, and the pressure pathway stays relatively stable as the active stretchable seal moves.

In some embodiments, the passive stretchable element is a flexible capsule connected to an ambient environment.

In some embodiments, the passive stretchable element is a flexible capsule connected to an ambient environment.

In some embodiments, the passive stretchable element is configured to prevent the movement of the first stimulation element from being hindered due to an air pressure imbalance.

In some embodiments, an inner wall of the flexible capsule defines a chamber connected to the enclosed space, due to a volume of the chamber changing as air pressure within the enclosed space changes in response to deformation of the active stretchable seal, thereby resulting in expansion and contraction of the flexible capsule.

In some embodiments, at least a portion of the housing is concave and forms a groove having an opening communicating with the enclosed space at a bottom wall thereof, and at least a portion of the flexible capsule is disposed inside the groove and sealingly engaged to the bottom wall of the groove, thereby resulting in the chamber being in communication with the enclosed space.

In some embodiments, the active stretchable seal is a bellows surrounding the relative movement part and extending or contracting as the first stimulation element moves.

In some embodiments, the housing further includes an annular element disposed about the active stretchable seal and configured to contact a portion of the human body as the first stimulation element stimulates the sensitive area of the human body.

In some embodiments, the annular element is flexibly and detachably mounted to the housing, and a gap is defined by an inner wall of the annular element and the bellows, and the gap is configured to accommodate a folded wall of the bellows as the bellows contracts.

In some embodiments, the first stimulation element includes a stimulation component, and the drive unit 16 includes power sources electrically connected to the stimulation component.

In some embodiments, the first stimulation element is connected to the drive unit via a quickly assemble-disassemble structure.

In some embodiments, the sexual stimulation device further includes two sets of electrically conductive assemblies, wherein one set of an electrically conductive contact of the electrically conductive assembly is disposed at the drive unit and is electrically connected to the power source, and another set of the electrically conductive contact of the electrically conductive assembly is disposed at the first stimulation section and is electrically connected to the stimulation component; and the two sets of conductive contacts touch one another when the first stimulation element is connected to the drive unit via the quick assemble-disassemble structure, thereby conducting power from the power source to the stimulation component.

In some embodiments, the first stimulation element is a dildo or an artificial vagina, and the stimulation component includes a vibration motor and/or a heating element.

In some embodiments, the enclosed space is defined by the active stretchable seal and the passive stretchable element, or the enclosed space is defined by the housing, the active stretchable seal, and the passive stretchable element.

In some embodiments, the enclosed space is airtight and/or watertight so as to impede liquid penetration into the drive unit inside the housing.

In some embodiments, the active stretchable seal is configured to deform with the movement of a first stimulation element, and the passive stretchable element is configured to deform passively due to the deformation of the active stretchable seal, thereby resulting in the dynamic balance of air pressure in an enclosed space at least defined by the passive stretchable element and the active stretchable seal. The sexual stimulation device further includes a pressure pathway carrying the pressure created by the active stretchable seal to the passive stretchable element such that the total pressure within the active stretchable seal, the passive stretchable element, and the pressure pathway stays relatively stable as the active stretchable seal moves. In some embodiments, the passive stretchable element is a flexible capsule connected to an ambient environment.

In some embodiments, a stimulator appendage is connected to the active stretchable seal 24 such that the stimulator appendage moves with respect to the body portion.

In some embodiments, the movement of the active stretchable seal is a reciprocating movement.

In some embodiments, the passive stretchable element is disposed within a cavity of the body that is hermetically sealed from the drive unit 16 and the active stretchable seal, and this cavity is open to the ambient environment by one or more openings in a housing of the body.

A sexual stimulation device includes: a housing, a drive mechanism disposed in the housing, an active deformable element coupled to the drive mechanism and configured to deform in response thereto to generate a pressure change, and a passive reconfigurable element configured to stimulate at least part of a sensitive area of a user. The active deformable element, the passive reconfigurable element, and the housing cooperatively define a substantially sealed space such that deformation of the active deformable element generates the pressure change within the substantially sealed space, and the pressure change is transmitted through the substantially sealed space to thereby passively reconfigure the passive reconfigurable element to provide stimulation to the at least part of the sensitive area.

In some embodiments, the sexual stimulation device includes a pressure pathway disposed within the substantially sealed space, and the pressure pathway is configured to transmit the pressure change generated by the active deformable element to the passive reconfigurable element.

In some embodiments, the pressure change within the substantially sealed space is dynamically redistributed within the substantially sealed space such that repeated deformation of the active deformable element induces corresponding passive reconfiguration of the passive reconfigurable element to achieve repeatable pressure cycling.

In some embodiments, the substantially sealed space includes an interior volume of the active deformable element, a pressure pathway, and a gap space between the passive reconfigurable element and the housing while excluding an interior volume of the passive reconfigurable element and an exterior space of the active deformable element.

In some embodiments, the drive mechanism is partially disposed inside the active deformable element and partially disposed between the active deformable element and the passive reconfigurable element.

In some embodiments, an end of the drive mechanism is fixedly connected to a closed end of the active deformable element, such that the drive mechanism drives the closed end of the active deformable element toward a motor of the drive mechanism to contract the active deformable element and reduces an inner space thereof, thereby reducing space occupied by the integrated drive mechanism and the active deformable element and facilitating miniaturization thereof.

In some embodiments, the drive mechanism includes a motor and a transmission mechanism coupled with the motor.

In some embodiments, the transmission mechanism is configured to convert rotary motion of the motor to a reciprocating motion of the active deformable element to control extension and contraction of the active deformable element.

In some embodiments, the transmission mechanism includes a thread pair and a sliding and guide assembly. The thread pair includes a screw rod and a movable member movable relative to the screw rod. The guide assembly is configured to guide a linear movement of the movable member.

In some embodiments, the motor is disposed between the active deformable element and the passive reconfigurable element.

In some embodiments, the active deformable element includes at least one of a bellows, a telescopic sleeve, a telescopic tube, a collapsible elastic bladder and corrugated flexible tube and a folded wall tube.

In some embodiments, at least a part of the active deformable element is configured to undergo visible reciprocating movement to provide a perceptible visual indication corresponding to dynamic changes in sexual stimulation applied by the passive reconfigurable element to the at least part of the sensitive area of the user.

In some embodiments, the sexual stimulation device includes a cover covering the active deformable element, and the cover is translucent.

A sexual stimulation device includes: a housing, a drive mechanism disposed in the housing, an active deformable element coupled to the drive mechanism and configured to deform in response thereto to generate a pressure change, and a passive reconfigurable element configured to stimulate at least part of a sensitive area of a user. The active deformable element, the passive reconfigurable element, and the housing cooperatively define a substantially sealed space, the pressure change is dynamically redistributed within the substantially sealed space as the pressure change is transmitted through the substantially sealed space to thereby passively reconfigure the passive reconfigurable element.

In some embodiments, the substantially sealed space includes a first pressure chamber in the active deformable element, a second pressure chamber between the passive reconfigurable element and the housing, and a pressure pathway configured to transmit the pressure change from the first pressure chamber to the second pressure chamber.

In some embodiments, the sexual stimulation device includes a support frame configured to support the drive mechanism.

In some embodiments, the sexual stimulation device includes a partition member, and an open end of the active deformable element is joined and sealed with the partition member.

In some embodiments, the pressure pathway extends through the partition member to provide fluid communication between the first pressure chamber and the second pressure chamber.

In some embodiments, the drive mechanism comprises a motor and a transmission mechanism coupled with the motor, and the transmission mechanism is configured to convert rotary motion of the motor into reciprocating linear movement of the active deformable element, thereby causing repeatedly stretching and retracting of the at least a portion of the active deformable element.

In some embodiments, the drive mechanism comprises a motor and a transmission mechanism coupled with the motor, the motor is disposed between the active deformable element and the passive reconfigurable element, and the transmission mechanism is partially disposed inside the active deformable element, thereby reducing space occupied by the integrated drive mechanism and the active deformable element and facilitating miniaturization thereof.

### BRIEF DESCRIPTION OF DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a cutaway view of a sexual stimulation device in accordance with exemplary embodiments of the present disclosure;

FIG. 2 is a cutaway view of a sexual stimulation device in accordance with exemplary embodiments of the present disclosure;

FIG. 3 is a perspective view of a sexual stimulation device having two stimulators in accordance with exemplary embodiments of the present invention;

FIG. 4 is a cutaway view of a sexual stimulation device in accordance with exemplary embodiments of the present disclosure;

FIG. 5 is a perspective view of a sexual stimulation device in accordance with exemplary embodiments of the present disclosure;

FIG. 6 is a perspective view of a sexual stimulation device having a handle element in accordance with exemplary embodiments of the present disclosure;

FIG. 7 is an exploded top-down view illustrating a sexual stimulation device in accordance with exemplary embodiments of the present disclosure;

FIG. 8 is an exploded bottom-up view of a sexual stimulation device in accordance with exemplary embodiments of the present disclosure;

FIG. 9 is a perspective view illustrating a sexual stimulation device in accordance with exemplary embodiments of the present disclosure;

FIG. 10 is a perspective view of a sexual stimulation device including an element on the far end of the base in accordance with exemplary embodiments of the present disclosure;

FIG. 11 is a perspective view illustrating a sexual stimulation device in a disassembled state in accordance with exemplary embodiments of the present disclosure;

FIG. 12 is a cutaway cross-sectional view of a sexual stimulation device in accordance with exemplary embodiments of the present disclosure;

FIG. 13 is a front view of a sexual stimulation device in accordance with exemplary embodiments of the present disclosure, with an active deformable element in an extended state;

FIG. 14 is a front view of a sexual stimulation device in accordance with exemplary embodiments of the present disclosure, with an active deformable element in a retracted state;

FIG. 15 is a partial exploded view of a sexual stimulation device in accordance with exemplary embodiments of the present disclosure;

FIG. 16 is a partial exploded view of a sexual stimulation device in accordance with exemplary embodiments of the present disclosure;

FIG. 17 is a front view of a portion of a sexual stimulation device in accordance with exemplary embodiments of the present disclosure;

FIG. 18 is a perspective view of a portion of a sexual stimulation device in accordance with exemplary embodiments of the present disclosure;

FIG. 19 is an exploded view of a portion of a sexual stimulation device in accordance with exemplary embodiments of the present disclosure;

FIG. 20 is a partial cross-sectional view of a sexual stimulation device in accordance with exemplary embodiments of the present disclosure, taken from a first viewing angle;

FIG. 21 is a partial cross-sectional view of a sexual stimulation device in accordance with exemplary embodiments of the present disclosure, taken from a second viewing angle;

FIG. 22A is a cross-sectional view of a sexual stimulation device in accordance with exemplary embodiments of the present disclosure, with a passive reconfigurable element in a retracted state; and

FIG. 22B is a cross-sectional view of a sexual stimulation device in accordance with exemplary embodiments of the present disclosure, with a passive reconfigurable element in an extended state.

### DESCRIPTION OF REFERENCE NUMERALS

10: housing; 110: opening; 16: drive unit; 20: interior cavity; 24: active stretchable seal; 28: passive stretchable element; 34: power source; 58: breather; 178: cap; 182: casing; 184: support frame; 186: first sub-frame; 188: second sub-frame; 190: first button; 192: second button; 194: third button; 196: mounting ring; 198: vibrating unit; 180: drive mechanism; 187: first open end of casing; 189: second open end of casing; 112: motor; 113: motor housing; 114: transmission mechanism; 116: partition member; 120: pressure pathway; 130: power source; 140: control circuit; 142: substrate; 144: electronic components; 150: one-way valve; 160: thread pair; 170: guide assembly; 171: slider; 172 guide rod; 200: active deformable element; 202: closed end of active deformable element; 204: first pressure chamber; 300: passive reconfigurable element; 320: second pressure chamber; 341: guide shafts; 356: protrusion structures; 402: first cover; 404: second cover.

### DESCRIPTION OF EMBODIMENTS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Unless otherwise defined, all technical and scientific terms used herein have the same meaning as commonly understood by one of ordinary skill in the art. The terminology used herein is for the purpose of describing particular embodiments only and is not intended to be limiting. Unless the context clearly indicates otherwise, singular terms include the plural and vice versa, and the terms “including,” “comprising,” “having,” and the like are intended to be open-ended and to mean “including, but not limited to.” As used herein, the terms “connected,” “coupled,” “linked,” and the like are used broadly and are not limited to a direct, physical connection. Unless otherwise explicitly stated, a first element (e.g., a component, unit, module, mechanism, member, or structure) may be connected/coupled/linked to a second element directly or indirectly, including via one or more intermediate elements, interfaces, fasteners, connectors, adapters, joints, mounts, housings, substrates, carriers, or other structures.

A connection/coupling may be permanent or removable; rigid or compliant; fixed or movable; and may include, by way of example, mechanical coupling (e.g., by contact, engagement, interference fit, snap fit, threaded engagement, weld, adhesive, clamp, pin, shaft, linkage, gear train, belt, chain, or bearing), electrical coupling (e.g., by wire, trace, bus, connector, or conductive interface), fluid coupling (e.g., by a passage, channel, conduit, port, manifold, valve, or sealed interface enabling fluid communication), and/or signal/communication coupling (e.g., by wired or wireless communication). The terms “directly connected/coupled” and “indirectly connected/coupled” are used when the nature of the connection is intended to be specified.

Exemplary embodiments of the present disclosure provide sexual stimulation devices that include a mechanism to balance internal pressure therein without compromising waterproofing. Rather than providing a vent hole that allows air to flow directly in and out of an active stretchable seal such as a reciprocating element, exemplary embodiments of the present disclosure provide a pathway for pressure to be balanced between the active stretchable seal that drives the motion of the stimulation device and a secondary passive stretchable element, which can be a passive stretchable element such as a flexible capsule, or a flexible wall, or an airbag including a certain amount of gas therein, disposed apart from the active stretchable seal. The secondary passive stretchable element is configured to enlarge as the active stretchable seal contracts and contract as the active stretchable seal enlarges. The pressure pathway between the active stretchable seal and the secondary passive stretchable element allows for the two elements to be part of a closed system with a constant pressure throughout.

For example, the active stretchable seal may be disposed close to a front end of the stimulation device and the secondary passive stretchable element may be disposed close to a back end of the stimulation device and the pathway may traverse the interior of the stimulation device. As the secondary passive stretchable element may itself expand and contract, and this secondary passive stretchable element may also be disposed within a casing of the stimulation device, a vent may be used to normalize pressure at the back end of the stimulation device so as to allow air to be pushed out from the casing as the secondary passive stretchable element expands and to allow air to be pulled into the casing as the secondary passive stretchable element contracts. Thus, there might still be a vent in use. However, this vent leads into a sealed compartment within the casing so even if fluid makes its way in through this vent, it is not able to enter the secondary passive stretchable element and therefore is not able to come into contact with any sensitive electronic or mechanical elements. Also, because this vent may be disposed on the back end of the stimulation device, fluid ingress is made less likely.

It is noted that while the active stretchable seal that drives the motion of the stimulation device may be an active element, which is to say, it may operate under the mechanical drive of a motor or other mechanism, the secondary passive stretchable element may be a passive element, which is to say, it does not operate by direct mechanical drive but rather it may expand and contract as a result of the pressure provided by the active stretchable seal, that travels through the pressure pathway. However, according to alternative embodiments, the secondary passive stretchable element may be the active element and the active stretchable seal, which drives the motion of the stimulation device, may be the passive element, being driven by the pressure created by the active secondary passive stretchable element.

Moreover, while the pressure pathway may include a tube or pipe element, this is not necessarily the case and the pressure pathway may be open within the internal cavity defined by the device body.

Additionally, while it is described above that the active stretchable seal, the secondary passive stretchable element, and the pressure pathway may be a closed system, i.e., not allowing any air to enter or exit the system, embodiments of the present disclosure are not necessarily limited thereto and there may be some degree of limited air transfer between this system and the ambient environment so as to allow the device to slowly normalize when brought into a low pressure or high pressure environment, such as when changing altitudes.

Thus, while various embodiments of the present disclosure are described herein, it is noted that the particular elements are offered as examples and the invention is not necessarily limited to having all of the various elements described herein. Rather, the various elements are described so as to provide examples of actual implementations of the described concept, which may include various ways to balance pressure within a sexual stimulation device.

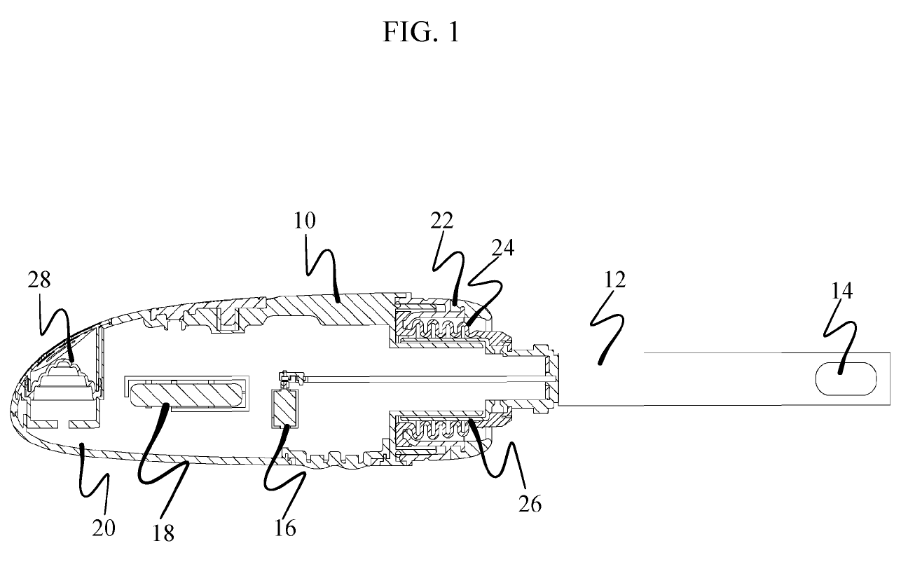

FIG. 1 is a cutaway view of a sexual stimulation device in accordance with exemplary embodiments of the present disclosure. In this device, the stimulator appendage is a fixed element that is arranged in line with the handle portion. As can be seen from this figure, the device includes an outer housing 10 that defines an exterior thereof. One or more stimulator appendages may extend from the outer housing 10. For example, a first stimulator 12 may extend from the housing 10. The first stimulator 12 may be a reciprocating element that is capable of providing a thrusting motion as it moves outwardly and inwardly. At the far end of the first stimulator 12 may be a stimulation component 14. The stimulation component 14 may be a vibrating motor or some other element capable of providing stimulation.

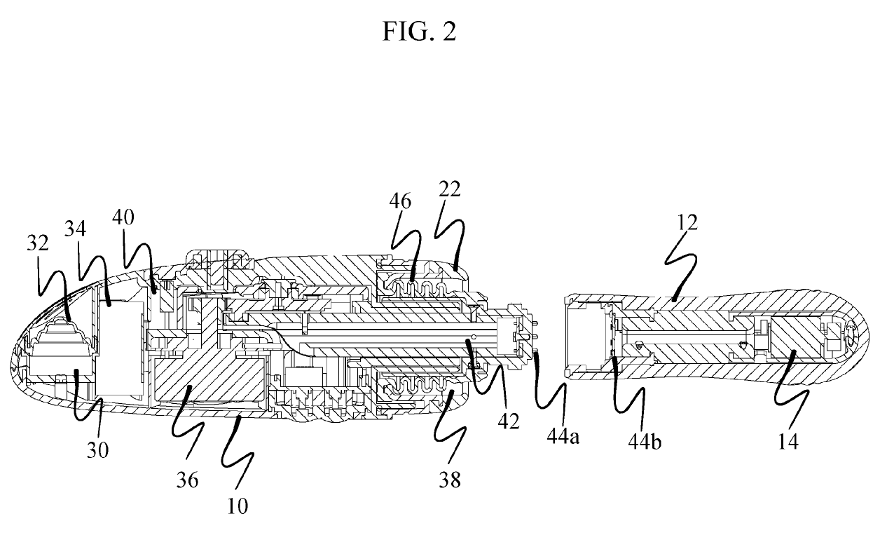

The reciprocating motion may be provided by a mover component 26 that is able to slide out and back under the action of a drive unit 16, which may include a motor and a mechanical linkage device. A stretchable sealer 24 may be used to ensure waterproofing across the mover component 26, for example, by providing a stretchable plastic element that may include bellows. An annular element 22 may be used to secure the stretchable sealer 24 to the housing 10. The relative moving part can be a portion between a mover component 26 and the housing, which exists as an air gap communicating with the interior of the housing 10, as shown in FIGS. 1 and 2, the air gap can be surrounded by the stretchable sealer 24, which may be a corrugated tube, for dynamic sealing. Furthermore, if the mover component 26 is a part of the first stimulator 12, then the relative moving part can be the air gap located between the first stimulator 12 and the housing 10.

The drive unit 16 may be powered by a power source such as a battery 18 and power conducting lines or wires may be used to deliver the power from the battery 18 to the drive unit 16. A controller may also be connected to the battery 18 and the drive unit 16 so as to control the operation of the drive unit 16.

As mentioned above, the drive unit 16 may drive the mechanical linkage to extend and retract the mover component 26. This may create pressure gradients within the housing 10 as the mover component 26 extends and retracts. For example, the extension of the mover component 26 may create a low pressure within an interior cavity 20 of the housing 10 that may be communicated to a passive stretchable element 28, which may function as the above-mentioned secondary passive stretchable element. In this way, the interior cavity 20 functions as the above-mentioned pressure pathway.

As the low pressure of the interior cavity 20 acts upon the passive stretchable element 28, the passive stretchable element 28 is made to contract. Air may then be permitted to enter into the housing 10 at an opening proximate to the passive stretchable element 28, but this section of the interior is hermetically sealed from the remainder of the interior cavity 20, and thus, even if water is to be pulled in through this opening, it cannot travel to the remainder of the interior cavity 20.

Additionally, as the mover component 26 retracts, high pressure is created within the interior cavity 20 and this may cause the passive stretchable element 28 to inflate within its space.

The stimulator appendage may be removable so as to allow for the use of multiple different stimulator appendages or to otherwise change the stimulator appendage that is in use. FIG. 2 is a cutaway view of a sexual stimulation device in accordance with exemplary embodiments of the present disclosure. In this device, the stimulator appendage is in line with the handle but is also removable. This figure illustrates the device with the stimulator appendage in a removed state.

The stimulator appendage may be a first stimulator 12 and may include a stimulation component 14. It is to be understood that within the present specification and the associated figures, like reference numerals may be used to describe like elements and thus, the stimulation component 14 (and other components) may be similar to that described above with respect to FIG. 1.

To power the stimulation component 14, electricity may be provided from the power source 34, which may be a battery 18, through a pair of electrically conductive contacts 44 with a first set of electrically conductive contacts 44 a on the handle of the device making contact with a second set of electrically conductive contacts 44b on the first stimulator 12. The bellows 46 may be locked in place by the annular element 22 or by a combination of the fixed retainer ring 94 and an element of the faceplate 50.

The gap 38 is defined by the annular element 22 and the outer side of the bellows 46. By enclosing the bellows 46 with the annular element 22, it prevents the bellows 46 from pinching the user's skin or body hair during contraction and expansion. A wire groove tube 42 may be part of the linkage element discussed above and may also serve as the aforementioned pressure pathway so as to communicate pressure to an enclosed space 40 of the housing 10 which may transfer pressure to a chamber 30 that the flexible capsule 32 is connected so that the flexible capsule 32 functions as the aforementioned secondary passive stretchable element.

The wire groove tube 42 may also function as the mechanical linkage transmitting motion from the motor 36 to the mover component 26.

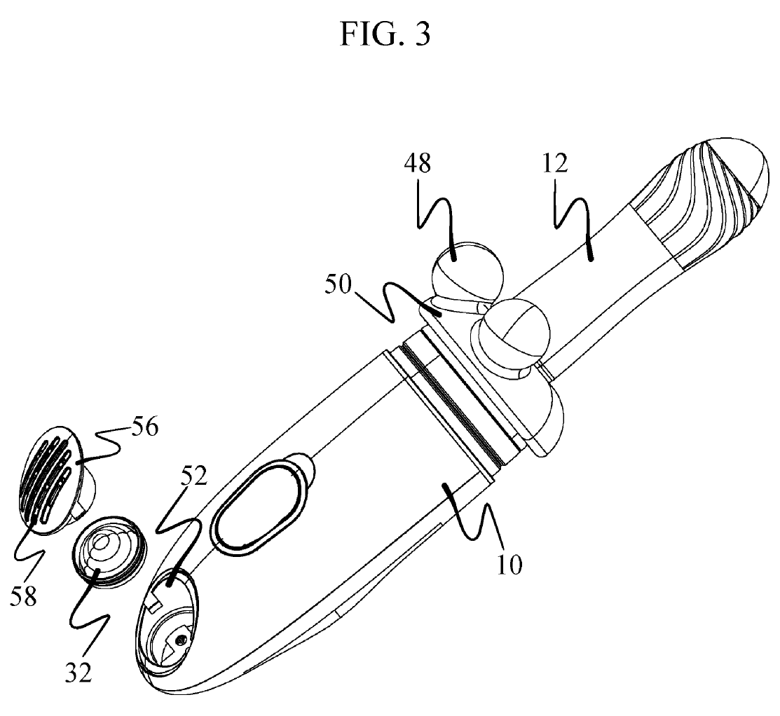

As described above, exemplary embodiments of the present disclosure may utilize multiple stimulators such as a first stimulator 12 and a second stimulator 48. FIG. 3 is a perspective view of a sexual stimulation device having two stimulators in accordance with exemplary embodiments of the present invention. As can be seen from this figure, in addition to the first stimulator 12, a second stimulator 48 may be present. A securing ring 80 may be attached to the second stimulator 48 so that the entire assembly may be removed and replaced or reattached.

The housing 10 may have an opening over the flexible capsule 32 which is shown, together with a cover 56, in an exploded fashion. The flexible capsule 32 may inflate and deflate in response to the pressure but may at all times be contained within the hermetically sealed portion of the housing 10. The cover 56 may lock in place with a groove 52 in the housing 10. In this way, the cover 56 may be removable for cleaning and then reattached for use.

When in use, air may travel in and out through openings in the cover than may be referred to herein as breathers 58. The breathers 58 may be open vents or may have a membrane or seal to allow the passage of air therethrough while keeping out liquid.

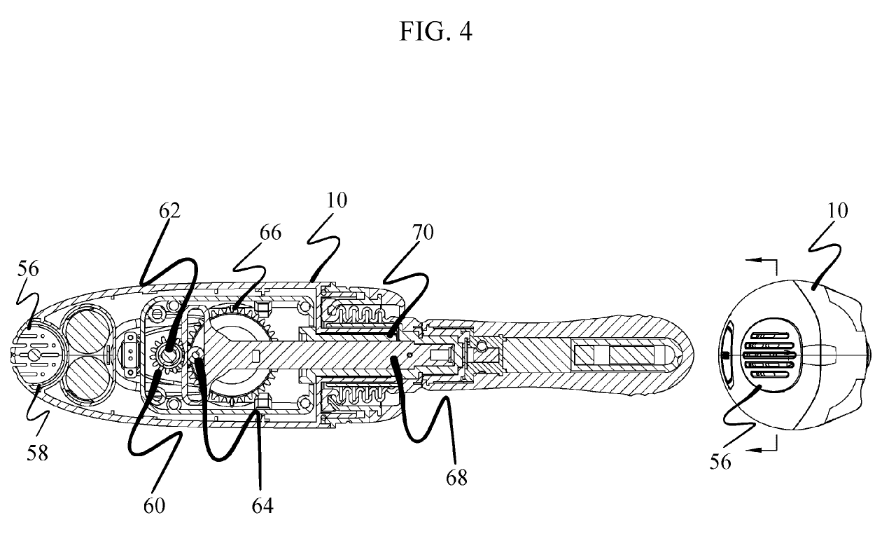

FIG. 4 is a cutaway view of a sexual stimulation device in accordance with exemplary embodiments of the present disclosure. To the right of the cutaway view is a bottom-up plan view. This figure shows the linkage mechanism for generating reciprocating motion from the motor 36. In this approach, the motor 36 has an output shaft 62 which turns a first gear 60. The first gear 60 turns a second gear 66. A slide 64 is disposed on the second gear 66 and as the second gear 66 turns, the slide 64 traces a circle. The slide 64 is disposed within a slot of a connecting rod 68 and so as the slide traces its circle, the connecting rod 68 moves up and down in a reciprocating fashion.

The connecting rod 68 is inhibited from lateral movement by a guide 70 and so the connecting rod 68 is forced into its reciprocating motion as the slide 64 moves laterally within the slot of the connecting rod 68 as it pushes and pulls the connecting rod 68 in its reciprocating motion.

The image to the right shows the bottom-up plan view of the sexual stimulation device. From this perspective, the cover 56 may be visible. This cover 56 includes the breather and may be removed to expose the flexible capsule 32 and to clean the space between the cover 56 and the flexible capsule 32.

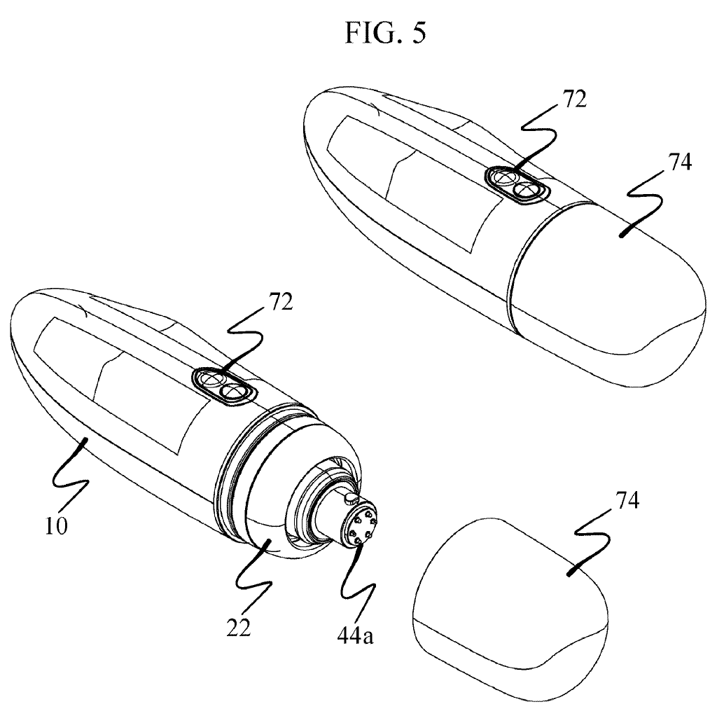

FIG. 5 is a perspective view of a sexual stimulation device in accordance with exemplary embodiments of the present invention. In this arrangement, the stimulation component 14 is removed from the housing 10 and a protective cap 74 is placed over the connection element. One or more control buttons 72 are visible on the surface of the housing 10. The control buttons 72 may be used to activate and deactivate the device and/or to provide other controls such as speed control, motion control, activation of the stimulation component, etc.

When the cap 74 is removed, the annular element 22 may be revealed as well as the electrically conductive contacts 44a.

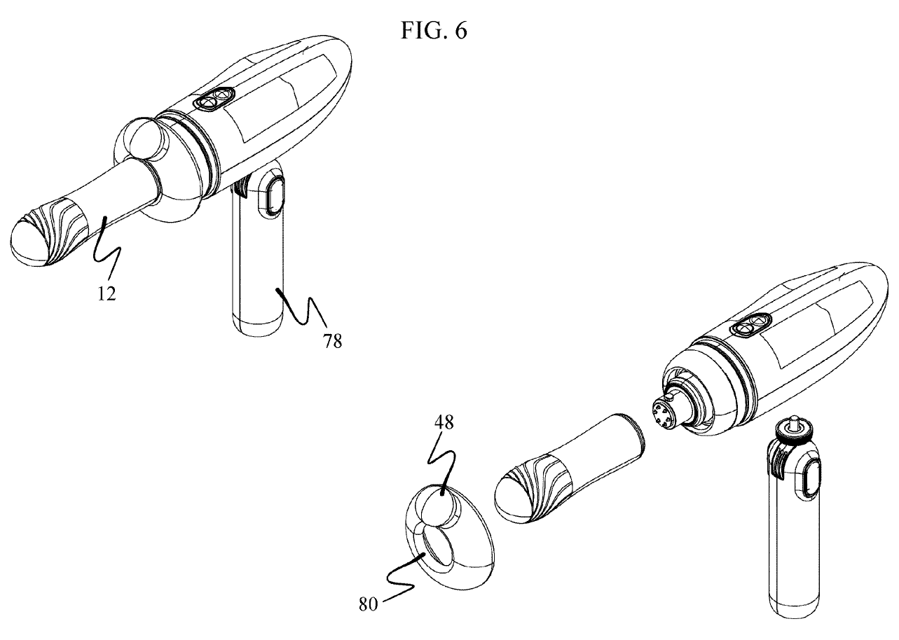

FIG. 6 is a perspective view of a sexual stimulation device having a handle element in accordance with exemplary embodiments of the present disclosure. As can be seen in this figure, the first stimulator 12 is disposed on a base portion that it is aligned with, i.e., both the first stimulator 12 and the base portion extend in the same direction and are arranged end-to-end. A handle portion 78 is then rotatably connected to the base portion. The second stimulator 48 is disposed at the base-facing end of the first stimulator 12. The second stimulator 48 may be removable from the first stimulator 12 and may be affixed thereto with the aid of a securing ring 80. The handle portion 78 may further be removably connected to the base and a hinge may be incorporated into the handle portion 78 to allow for the handle portion 78 to be angled, with respect to the base portion, to a desired and comfortable extent.

The cover 56 and breather 58 may be disposed at a back end of the base or may be disposed on a back end of the handle portion 78. Where the cover 56 and breather 58 are disposed at the back end of the handle portion 78, the pressure pathway may continue from the base to the handle portion 78.

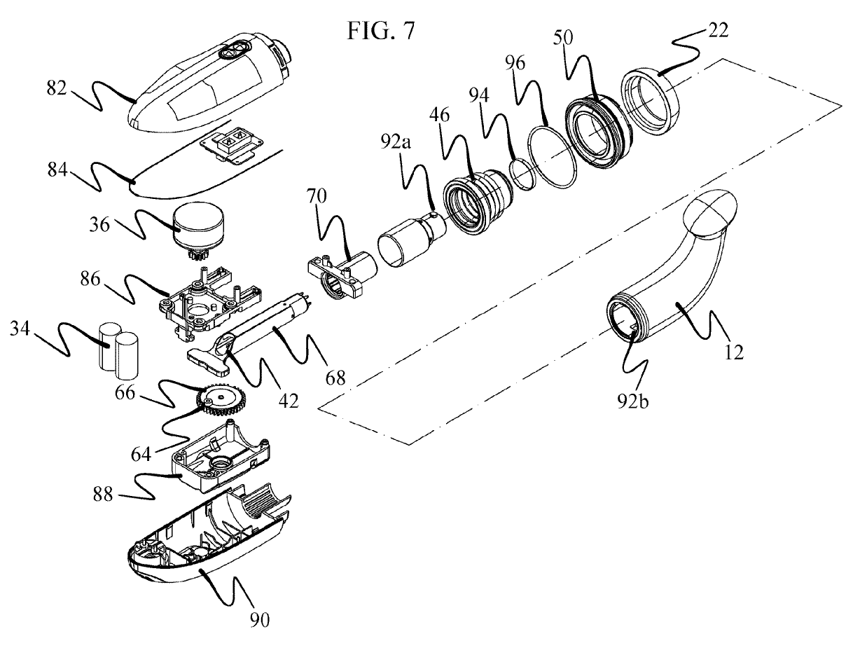

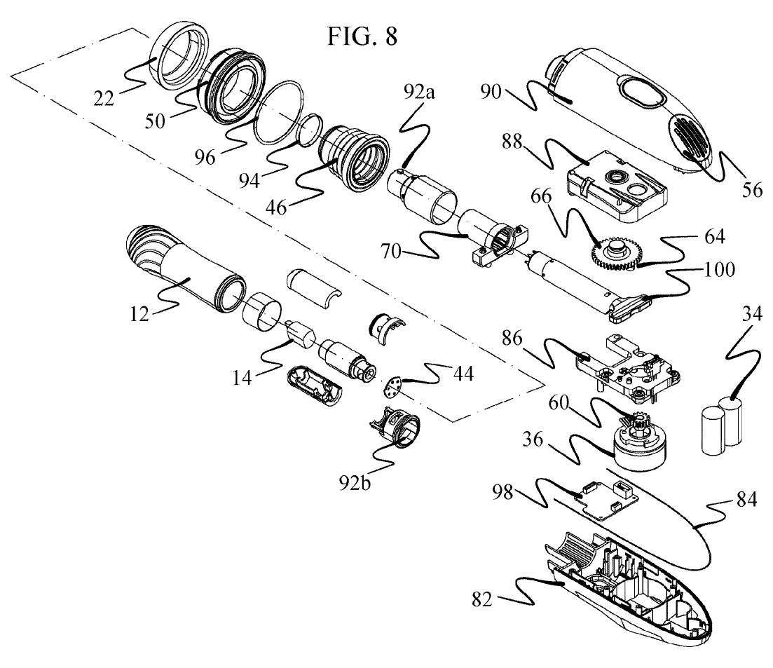

FIG. 7 is an exploded top-down view illustrating a sexual stimulation device in accordance with exemplary embodiments of the present disclosure and FIG. 8 is an exploded bottom-up view of the same. In these figures, it can be appreciated that the housing 10 includes an upper housing 82 and a lower housing 90, which may come together with a sealing strip 84 disposed therebetween to make a watertight connection, which may be a U-shaped element. A printed circuit board (PCB) 98 may be disposed within the housing 10, so as to control the operation of the device and one or more integrated circuits or other circuit elements may be disposed on the PCB 98.

The motor 36, having a first gear 60 attached to its output shaft 62 may be disposed within a motor bracket 86 such that the first gear 60 engages with the second gear 66 with the slide 64 of the second gear 66 disposed within the slide groove 100 of the connecting rod 68. The second gear 66 may be disposed within a gear cover 88 that the second gear 66 may rotate within.

The motor 36 may receive power from the power source 34 and may operate under the control of the controller that may be embodied by the PCB 98.

The connecting rod 68 may be restricted from lateral motion by the guide 70 such that the connecting rod 68 moves in a reciprocating fashion as a result of the movement of the motor 36. As the first stimulator 12 is removable, a quick linkage element may be used to facilitate the connection and disconnection and carry power thereacross. The quick linkage element may include a first portion 92 a affixed to the body and a second portion 92 b affixed to the first stimulator 12.

As shown in FIG. 7, within the connecting rod 68, there is an internal wire groove tube 42. The wire groove tube 42, located at one end within the housing 10, has an outlet for leading a wire connected to the first electrically conductive contact 44 a out of the housing 10. The outlet is sloped to prevent the wire from being pulled during the reciprocating movement of the connecting rod 68.

Bellows 46, that may be made of a flexible and waterproof material such as silicone, may cover the guide 70 and connecting rod 68, such that the body may remain waterproof even as the connecting rod 68 extends and retracts. The bellows 46 may be held in place by a retainer ring 94. Sealings 96 may be used to maintain a good waterproof seal between the housing 10 and the faceplate 50.

The annular element 22 may cover the retainer ring 94 and may link with the faceplate 50 so as to hold it in place during use.

Electrically conductive contacts 44 may be disposed within the quick linkage 92 a/b so as to facilitate the transmission of electricity from the body to the first stimulator 12 so as to deliver power to the stimulation component 14, which may be disposed in a front end of the first stimulator 12. The first stimulator 12 may be fashioned to have any desired shape and different first stimulators 12 may be attached to the base, as desired. FIG. 7 shows one exemplary shape for the first stimulator 12 and FIG. 8 shows another exemplary shape for the first stimulator 12, however, other shapes may also be used within the spirit and scope of the present disclosure.

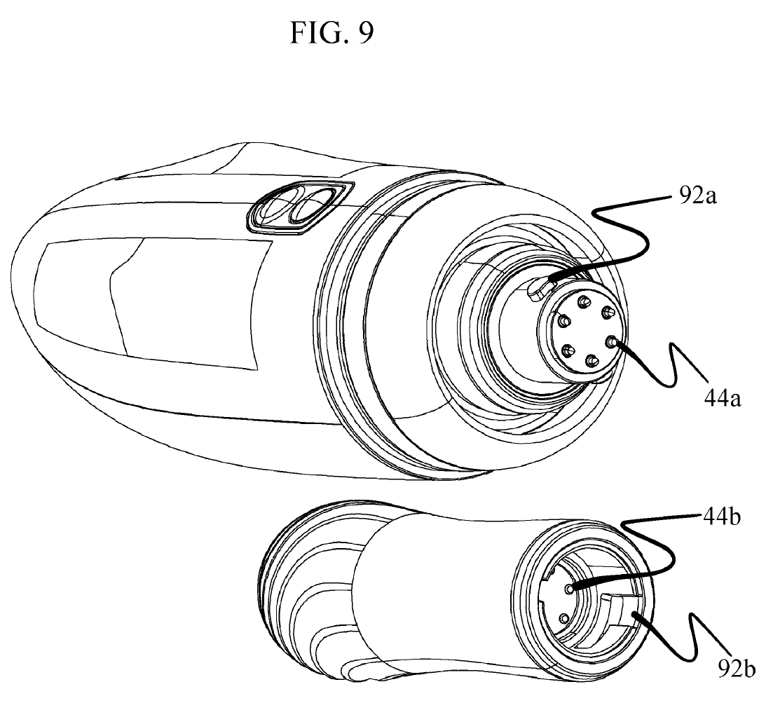

FIG. 9 is a perspective view illustrating a sexual stimulation device in accordance with exemplary embodiments of the present disclosure. In this figure, the first stimulator 12 is shown in a disconnected state so that the means of connection may be appreciated. The electrical connection between the body and stimulator 12 is made by the aforementioned electrically conductive contacts 44, including a first contact 44a disposed on the body and a second contact 44b disposed on the stimulator 12. The contacts 44a/b are arranged to engage with one another in the connected state.

The physical connection between body and stimulator 12 is maintained by the quick linkage assembly 92, including the first linkage 92a disposed on the body and the second linkage 92b disposed on the stimulator 12. The first linkage 92a may be a protrusion and the second linkage 92b may be a channel for receiving the protrusion, but this is only an example and other arrangements may be used, including mechanical arrangements and magnetic arrangements for holding the stimulator 12 in place.

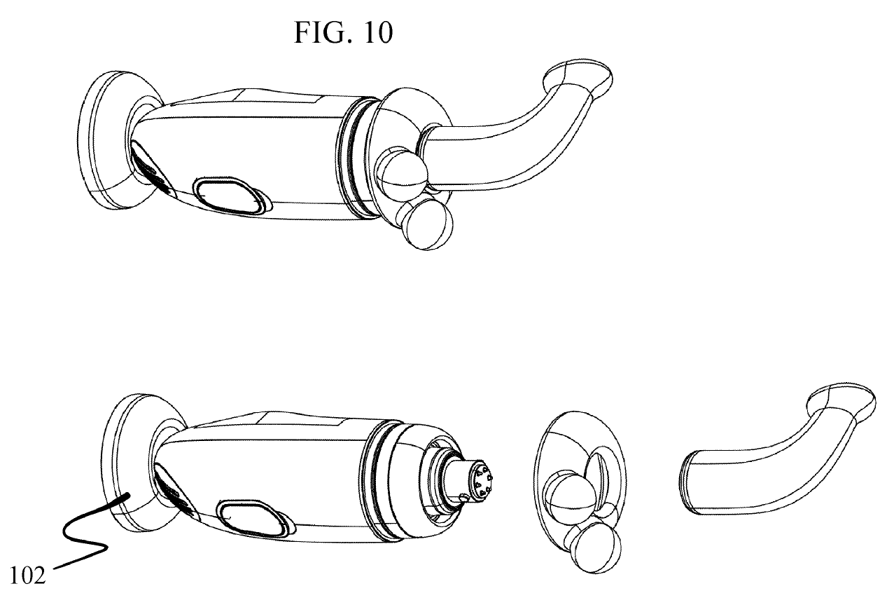

The sexual stimulation device may further include an element disposed on the far end of the base. FIG. 10 is a perspective view of a sexual stimulation device including an element on the far end of the base in accordance with exemplary embodiments of the present disclosure. This element may be a sucker element 102 configured to apply an intermittent negative pressure. The negative pressure may be provided by the breather 58. As can be appreciated from this figure, the second stimulator 48 may be disposed on the removable base and together these elements may be held in place by the engagement of the first stimulator 12 with the body through the quick linkage assembly 44.

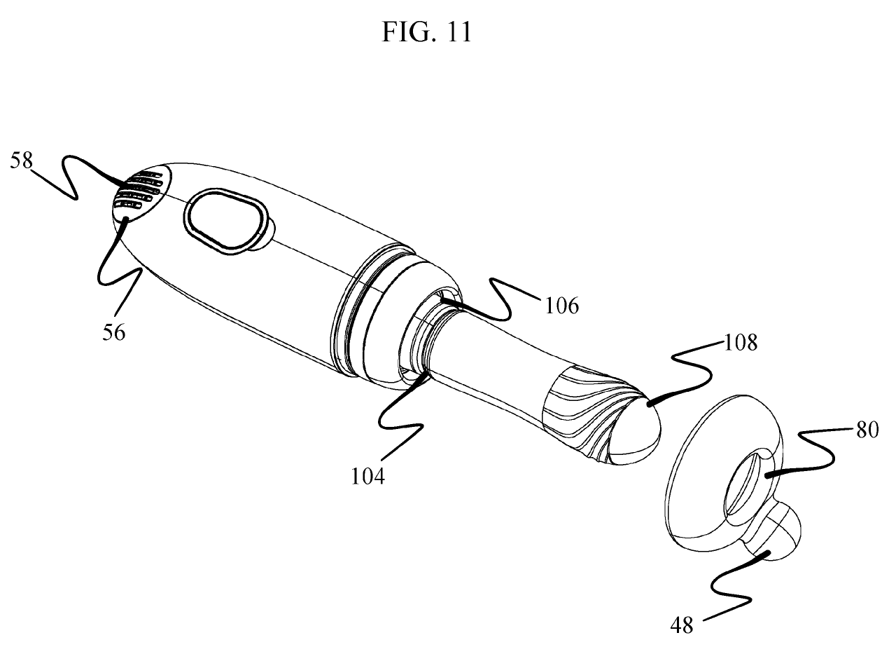

FIG. 11 is a perspective view illustrating a sexual stimulation device in a disassembled state in accordance with exemplary embodiments of the present disclosure. As can be seen from this figure, the first stimulator 12 may be a dildo coupled to a removable attachment. The dildo has a first end 106 and a second end 108. The first end 106 is coupled with the drive unit 16 and the second end 108 is configured to be inserted into, for example, a female user's vagina. The removable attachment is coupled between the first end 106 and the second end 108 of the dildo. The dildo further includes an annular concavity 104 surrounding an outer side wall proximate the first end 106. The removable attachment further includes a securing ring 80 corresponding to the annular concavity 104. Divided by the annular concavity 104, a diameter of a portion of the dildo located on a side where the first end 106 is located is greater than the diameter of a portion of the dildo located on a side where the second end 108 is located. The securing ring 80 has an interference fit with the portion of the dildo located on the side where the first end 106 is located as the removable attachment is coupled with the dildo. The second stimulator 48 may be connected to the faceplate 50, past the securing ring 80, and may include additional stimulation components or may simply offer passive stimulation by its shape.

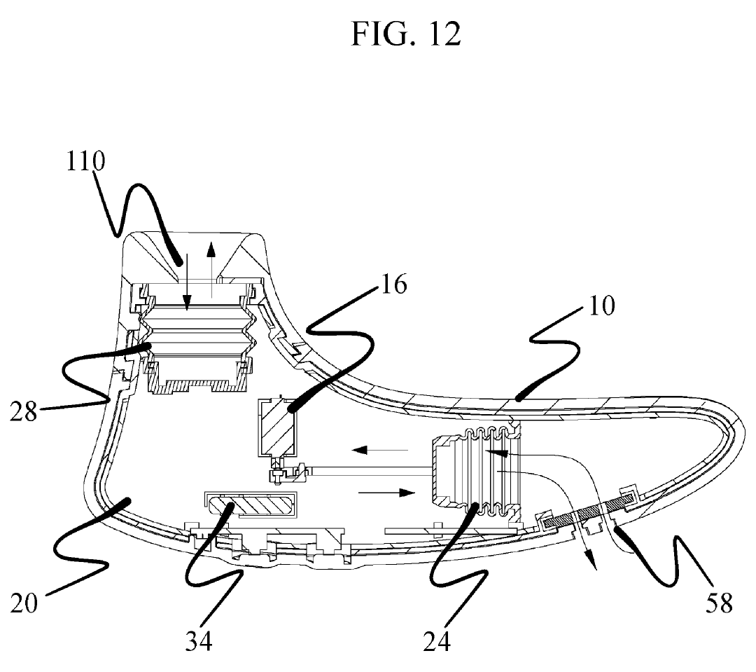

FIG. 12 is a cutaway cross-sectional view of a sexual stimulation device in accordance with exemplary embodiments of the present disclosure. As can be seen from this figure, it is the stretchable sealer 24 of the secondary passive stretchable element that is actively driven by the drive unit 16. The stretchable sealer draws in and pushes out air through the breather 58 by the direct application of the mechanical force of the drive unit 16 that is powered by the power source 34. The pressure pathway is defined within the interior cavity 20 of the housing 10 so as to passively move the passive stretchable element 28, which here delivers sexual stimulation to the user through an opening 110. Because the opening 110 and the passive stretchable element 28 are hermetically sealed from the interior cavity 20, there is no risk of liquid penetrating the interior cavity where it can damage the device. There is also no need to actively drive the passive stretchable element 28 as it may be passively operated by the communication of pressure thereto through the pressure pathway of the interior cavity 20.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

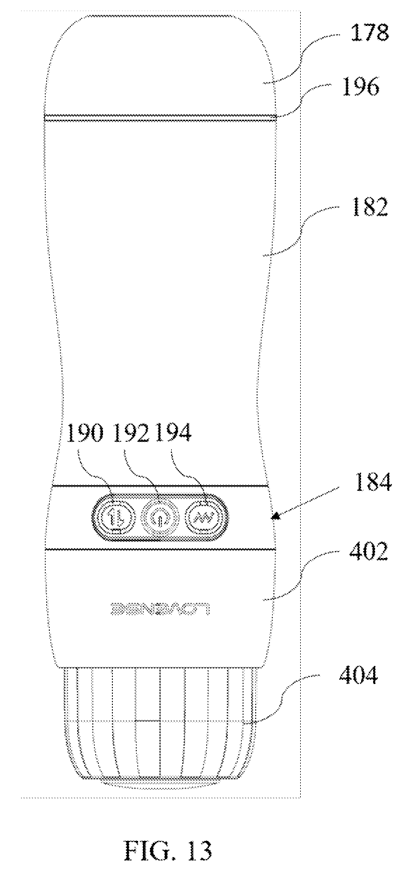

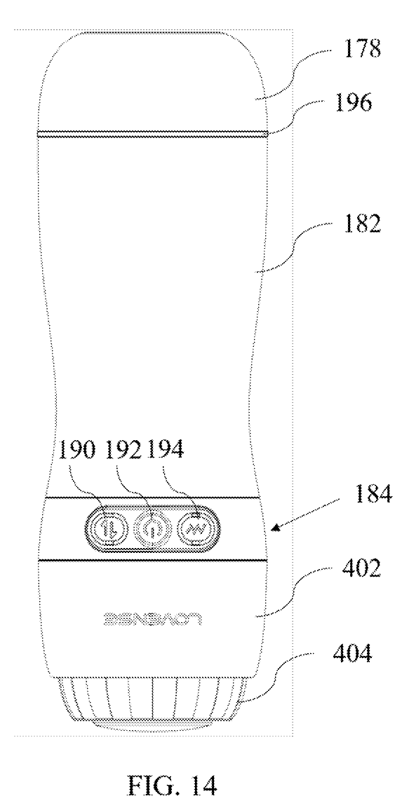

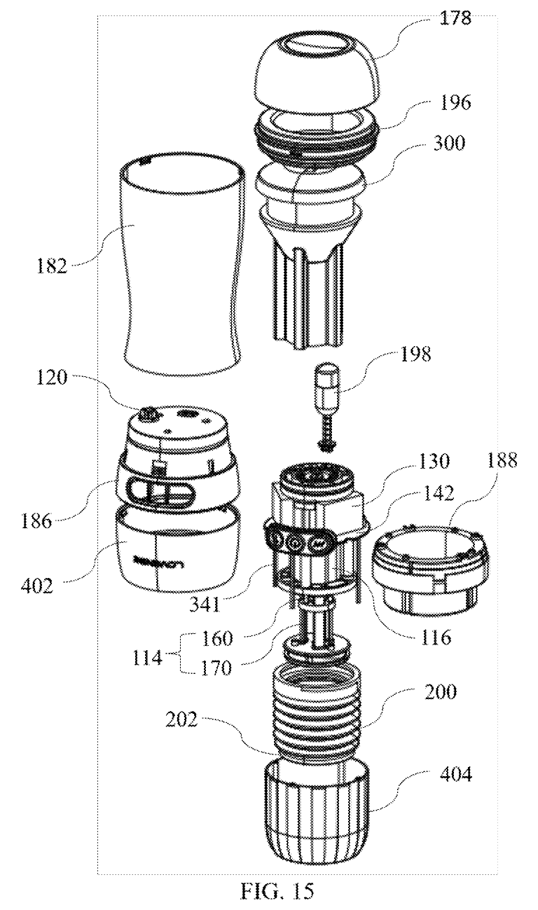

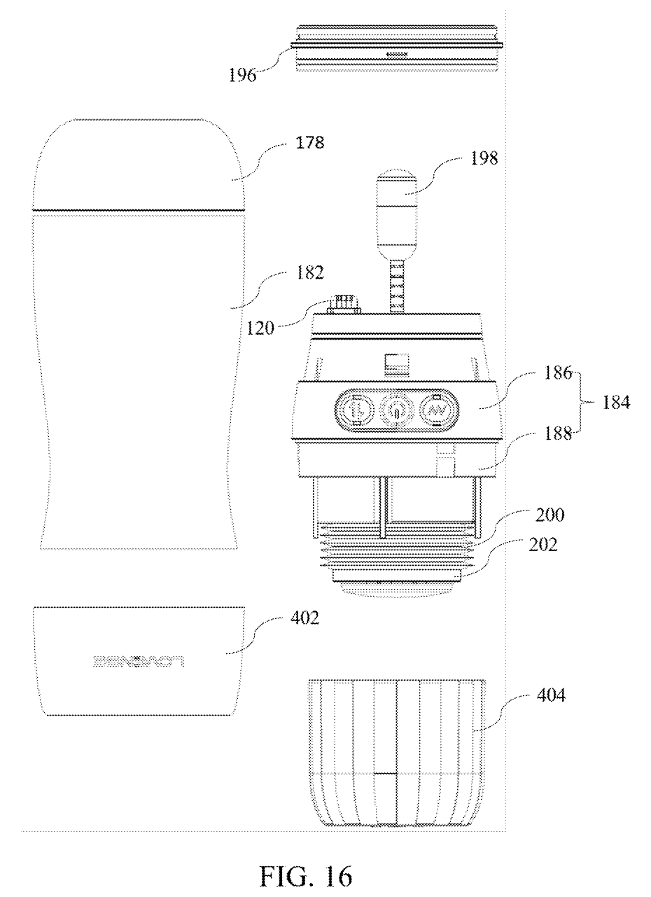

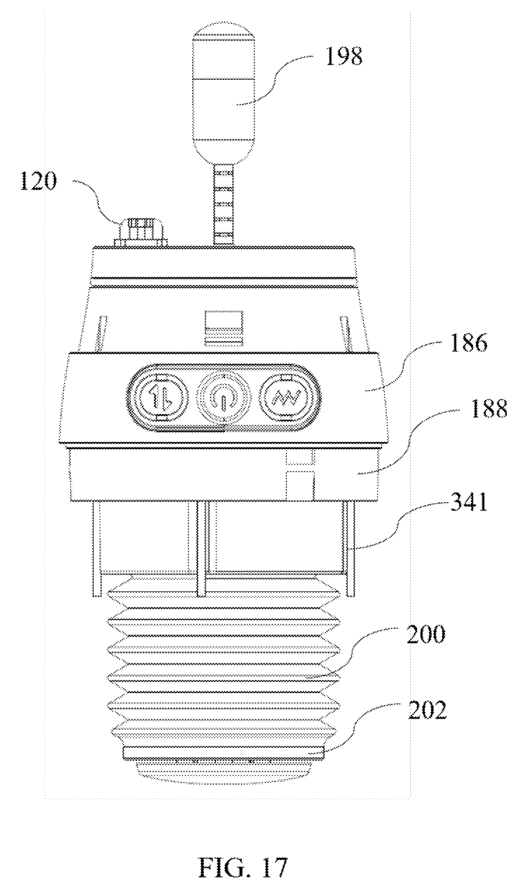

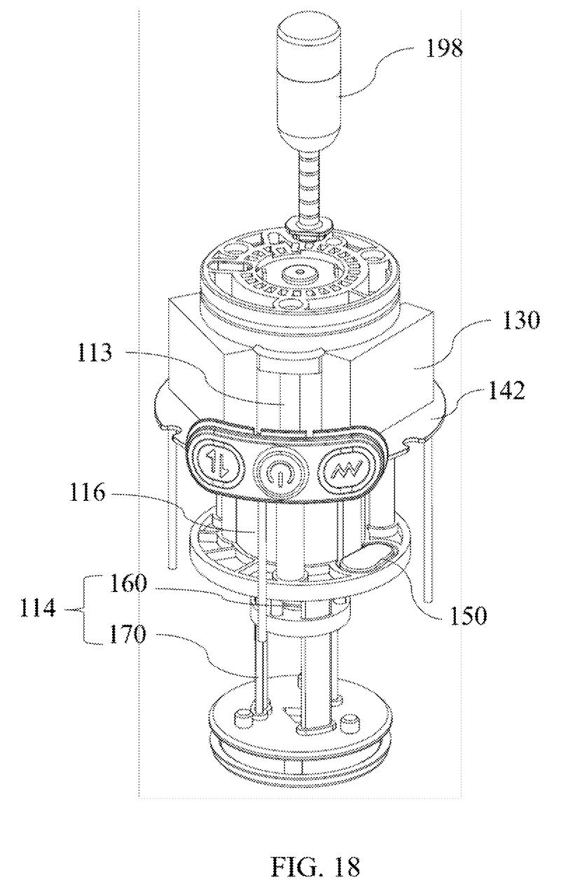

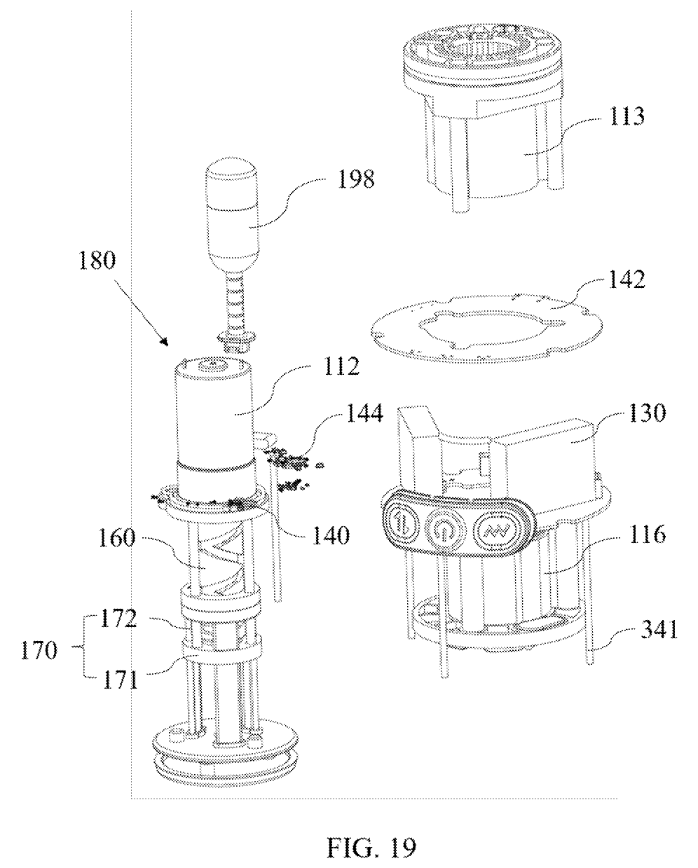

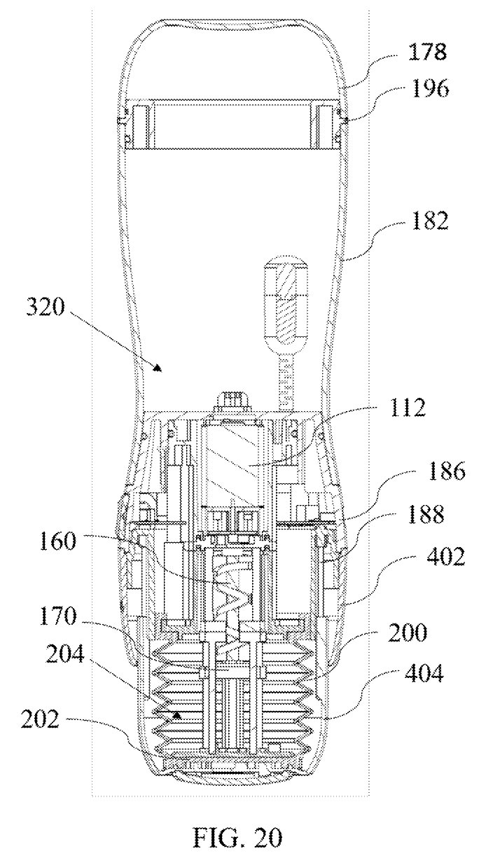

FIGS. 13 to 21 illustrate a sexual stimulation device according to exemplary embodiments.

In exemplary embodiments shown in FIGS. 13 to 21, the sexual stimulation device has a masturbation cup architecture using associated pressure-transmission and sealing techniques, in which a deformable element is actively driven to induce a controllable pressure change within a sealed space, thereby passively reconfiguring a flexible stimulation element so as to provide suction stimulation.

As shown in FIGS. 13 to 22, in some embodiments, the sexual stimulation device includes a housing, a drive mechanism 180, a pressure pathway 120, an active deformable element 200, and a passive reconfigurable element 300. The housing may include a casing 182 and other covers. The term “drive mechanism” used herein refers to and corresponds to the “drive unit” disclosed above. Accordingly, the drive mechanism described herein may have the same structure, function, and operation as the drive unit described in the above embodiment. The terms “active deformable element” and “passive reconfigurable element” used herein may refer to and correspond to the stretchable sealer and secondary passive stretchable element described above, respectively. Accordingly, the active deformable element and the described secondary passive stretchable element herein may have the same structure, function, and operation as the stretchable sealer and secondary passive stretchable element described in the above embodiment.

The casing 182 is configured to accommodate the drive mechanism 180. In some embodiments, the casing 182 is hollow and defines an inner space. The casing 182 may have a generally cylindrical shape. However, a radial cross-section of the casing 182 may alternatively have other shapes, such as an oval shape, a square shape, a rectangular shape, a diamond shape, or other regular or irregular shapes. In some embodiments, the casing 182 may have an irregular column-like structure including one or more locally narrowed portions (e.g., waist-like portions) formed along a longitudinal direction thereof. The casing 182 may be formed from one or more materials, such as plastics (e.g., ABS, PC, PC/ABS, PP, or PA), metals (e.g., aluminum alloy or stainless steel), and/or combinations thereof. The casing 182 includes a first open end 187 and a second open end 189 that are opposite to each other.

The drive mechanism 180 is disposed in the casing 182 and configured to provide a driving movement. The drive mechanism 180 further includes a motor 112 and a transmission mechanism 114 coupled with the motor 112.

The motor 112 is configured to provide a mechanical driving force. In some embodiments, the motor 112 is an electric stepper motor, a servo motor, a linear motor, or other suitable actuator. In some embodiments, the motor 112 is configured to operate at one or more selectable speeds and/or torque levels to achieve different stimulation effects.

The transmission mechanism 114 is coupled with the active deformable element 200 and configured to convert the driving movement to a reciprocating motion of the active deformable element 200 to control extension and contraction of the active deformable element 200. In some embodiments, the transmission mechanism 114 may be a reciprocating mechanism, such as, a screw-type reciprocating transmission mechanism. The reciprocating mechanism may include a thread pair 160 and a sliding and guide assembly 170. The thread pair 160 may include a screw rod and a movable member movable relative to the screw rod. The movable member may be a nut, bracket or a carrier. The sliding guide assembly 170 may include a guide rod 172 and optionally a slider 171. The guide rod 172 is configured to guide the linear movement of the movable member and/or the slider 171. The slider may be a sliding block, a sliding sleeve, a sliding plate, a sliding bracket, a sliding carrier, a sliding seat or a sliding base. In the present embodiment, although an outer surface of the screw rod is provided with a helical groove and the movable member moves within the helical groove, the movable member and the slider 171 can only perform reciprocating linear movement along the guide rod 172 because the guide rod 172 extends linearly. The thread pair and the sliding and guide assembly cooperatively configured to convert a rotational movement of the motor into a reciprocating linear movement of the movable member and the slider 171, thereby causing a portion of the active deformable element 200 connected to the transmission mechanism 114 to perform reciprocating linear movement. In some embodiments, the movable member and the slider 171 may be integrally formed.

The thread pair 160 may be directly coupled with the motor 112, for example, by threaded connection, or indirectly coupled with the motor 112 via an intermediate member such as a shaft coupling.

The reciprocating mechanism is coupled with the drive mechanism to convert the rotary motion of the motor 112 into a reciprocating linear motion of the active deformable element 200, thereby repeatedly stretching and retracting at least a portion of the active deformable element 200. In some embodiments, an end of the reciprocating mechanism is connected to a closed end 202 of the active deformable element 200.

In some embodiments, a power source 130 is provided inside the casing 182 to provide power to the motor 112 and other power-consuming components. For example, the power source may include one or more disposable batteries (e.g., AA batteries or AAA batteries), one or more rechargeable batteries (e.g., lithium-ion, lithium-polymer, or NiMH battery packs), and/or a wired power input (e.g., a USB power input or other external power adapter). In some embodiments, the power source is configured to be rechargeable and may include a charging interface and an associated charging circuit.

In some embodiments, a control circuit 140 is provided inside the casing 182 and configured to control the timing and rotational speed of the motor 112. For example, the control circuit 140 may include, without limitation, a motor driver circuit (e.g., an H-bridge driver, a PWM driver, or a BLDC driver), a speed/position sensing circuit (e.g., based on Hall sensors, encoders, back-EMF sensing, or current sensing), and/or a protection circuit (e.g., overcurrent, overtemperature, or undervoltage protection). In some embodiments, the control circuit 140 further includes a controller and a memory. The controller may include a CPU, a microcontroller unit (MCU), a digital signal processor (DSP), a system-on-chip (SoC), or other suitable processor. The memory may include non-volatile memory and/or volatile memory, such as ROM, flash memory, EEPROM, SRAM, or DRAM. The memory may store one or more computer-readable instructions that, when executed by the controller, control operation of the motor 112 and thus control a frequency and an amplitude (or degree) of pressure variation within the enclosed space (e.g., interior cavity of the casing 182), thereby enabling a user to experience different stimulation modes.

In some embodiments, the sexual stimulation device further includes a heating unit and/or a vibrating unit 198. The heating unit may include, for example, a resistive heating element, a flexible heating film, a PTC heater, or a heatable wire embedded within or adjacent to the passive reconfigurable element 300 and/or the opening thereof. The vibrating unit 198 may include, for example, an eccentric rotating mass (ERM) motor, a linear resonant actuator (LRA), a piezoelectric vibrator, or other suitable vibration generator. In some embodiments, the control circuit 140 is further configured to control vibration frequency and/or intensity of the vibrating unit 198 and/or to regulate a heating temperature and/or a heating profile of the heating unit (e.g., via PWM control, thermostatic control, and/or temperature feedback from a sensor).

In some embodiments, the sexual stimulation device further includes a support frame 184 configured to protect and support the drive mechanism 180 and other internal components, such as the power source 130 and the control circuit 140. The top portion of the support frame 184 forms an air-tight sealing engagement with the second open end 189 of the casing 182. In some embodiments, the support frame 184 includes a first sub-frame 186 and a second sub-frame 188. The first sub-frame 186 is configured to accommodate the motor 112 and one or more electronic components. The second sub-frame 188 is configured to accommodate the transmission mechanism 114. In some embodiments, the motor 112 is contained in a motor housing 113 that is fixed to the second sub-frame 188 to maintain alignment between the motor 112 and the transmission mechanism 114. In some embodiments, the electronic components 144 and the control circuit 140 are provided on a substrate 142, such as a printed circuit board (PCB), and the substrate 142 is disposed between the first sub-frame 186 and the second sub-frame 188 and is electrically connected to the motor 112 and the power source 130. In some embodiments, an LED indicator connected to the substrate extends through a hole in the first sub-frame 186.

In some embodiments, the sexual stimulation device further includes a controlling mechanism, for example, a first button 190, a second button 192, and a third button 194. By way of example, the first button 190, the second button 192, and the third button 194 may correspond to a vibration button, an on/off button, and a telescoping button, respectively. In some embodiments, the first button 190, the second button 192, and the third button 194 are provided on the first sub-frame 186 and are operatively coupled to the control circuit 140 to control operating modes of the sexual stimulation device, such as enabling/disabling vibration (via the vibrating unit 198), adjusting intensity levels, starting/stopping the motor 112, and initiating a telescoping operation (e.g., telescopic relative movement between the casing 182 and the active deformable element 200).

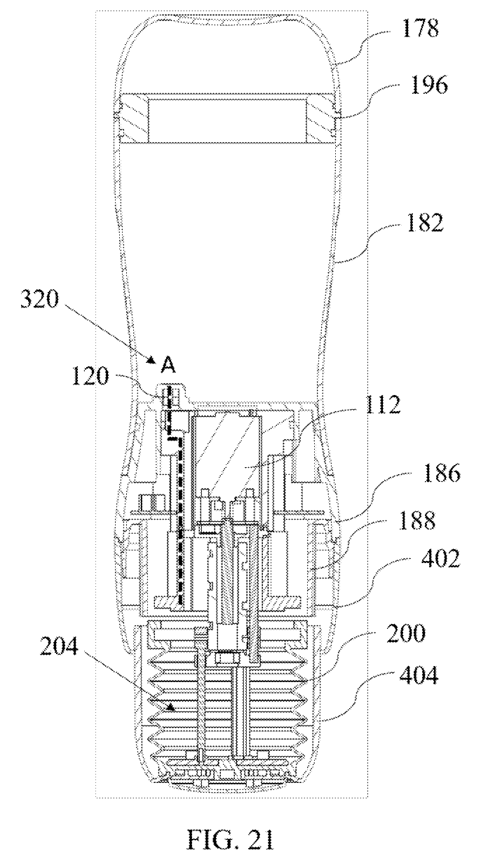

The active deformable element 200 is mechanically coupled to the drive mechanism 180 and configured to deform in response thereto to generate a pressure change, specifically, configured to deform with the driving movement so as to generate a pressure change. In some embodiments, the active deformable element 200 may be a bellows (e.g., a corrugated bellows) configured to extend and contract along a longitudinal direction of the casing 182. In some embodiments, the active deformable element 200 may be telescoping sleeve, telescopic tube, corrugated sleeve, collapsible elastic bladder, corrugated flexible tube, folded wall tube. The active deformable element 200 has an open end and an opposite closed end 202. In some embodiments, the reciprocating mechanism is partially disposed inside the active deformable element 200 and partially accommodated within the support frame 184. One end of the reciprocating mechanism is fixedly connected to the closed end 202 of the active deformable element. The active deformable element 200 is deformable, such that the volume of an internal cavity thereof changes to cause a variation in air pressure. The motor 112 is further arranged inside the support frame 184. A first pressure chamber 204 is disposed within the active deformable element and is jointly defined by the active deformable element 200 and the portion of the reciprocating mechanism disposed inside the active deformable element 200. In some embodiments, A partition member 116 is arranged between the portion of the reciprocating mechanism accommodated within the support frame 184 and the support frame 184. The open end of the active deformable element 200 is joined and sealed with the partition member 116. A pressure pathway 120, for example, an airflow passage, is formed inside the partition member 116, with one end of the airflow passage communicating with the first pressure chamber 204 and the other end communicating with a second pressure chamber 320, extends through the partition member to provide fluid communication between the first pressure chamber and the second pressure chamber, as shown in FIG. 21. The partition member116 may be an interface connector or a flow channel base. The partition member 116 may be integrally formed as a single piece, or may be assembled from a plurality of structural components if integral molding is impractical due to special structural configuration requirements. The open end of the active deformable element is in fluid-tight sealing engagement with an end of the partition member at the mating interface, to hermetically seal the first pressure chamber at the joint. The deformable configuration of the active deformable element 200, combined with the layout arrangement that the reciprocating mechanism is partially disposed inside the active deformable element 200 and partially disposed between the active deformable element and the passive reconfigurable element 300, more specifically, partially accommodated within the support frame 184, enables effective integration of the transmission mechanism 114 and the active deformable element 200. Such structural integration remarkably reduces the overall installation and occupied space of the assembly of the transmission mechanism 114 and the active deformable element 200. An end of the drive mechanism is fixedly connected to a closed end of the active deformable element, such that the drive mechanism drives the closed end of the active deformable element toward a motor of the drive mechanism to contract the active deformable element and reduces an inner space thereof, thereby reducing space occupied by the integrated drive mechanism and the active deformable element and facilitating miniaturization thereof. Furthermore, the present structure generates lower operating noise compared with conventional air pump assemblies adopting a solenoid valve scheme.

In some embodiments, the reciprocating mechanism is coupled to the closed end 202 of the bellows-shaped active deformable element 200 such that the reciprocating movement of the reciprocating mechanism causes the active deformable element 200 to extend and retract. For example, when the reciprocating mechanism moves back and forth under the drive of the motor 112, the closed end 202 of the active deformable element 200 is pulled and pushed accordingly, thereby changing the effective volume of the first pressure chamber 204 and causing a corresponding pressure variation within the first pressure chamber 204. The pressure variation causes the passive reconfigurable element 300 to reconfigure, such as deform, displace, move, or a combination thereof, thereby providing suction stimulation and/or other sexual stimulation effects to a user. In some embodiments, at least a part of the active deformable element 204, for example, the closed end, is configured to undergo visible reciprocating movement to provide a perceptible visual indication corresponding to dynamic changes in a sexual stimulation applied by the passive reconfigurable element to at least part of the sensitive area of the user. More specifically, one end of the reciprocating mechanism is coupled to the closed end 202 of the bellows-shaped active deformable element 200. The end of the reciprocating mechanism is provided with two disc-shaped plate the closed end 202 of the bellows-shaped active deformable element 200 is disposed between the two disc-shaped plates to form a stable connection.

The passive reconfigurable element 300 is configured to stimulate at least part of a sensitive area of a user. The passive reconfigurable element 300 is connected to the casing 182 and configured to reconfigure in response to the pressure change to provide sexual stimulation to at least part of the sensitive area of the user.

The active deformable element, the passive reconfigurable element, and the housing cooperatively define a substantially sealed space such that deformation of the active deformable element generates the pressure change within the substantially sealed space, the pressure change being transmitted through the substantially sealed space to thereby passively reconfigure the passive reconfigurable element to provide stimulation to at least part of the sensitive area.

In some embodiments, the pressure change within the substantially sealed space is dynamically redistributed within the substantially sealed space such that repeated deformation of the active deformable element induces corresponding passive reconfiguration of the passive reconfigurable element to achieve repeatable pressure cycling.

In some embodiments, the passive reconfigurable element 300 is configured to reconfigure passively due to the deformation of the active deformable element 200, thereby establishing a dynamic air-pressure balance within the substantially sealed space.

In some embodiments, the substantially sealed space includes an interior volume of the active deformable element, the pressure pathway, and a gap space between the passive reconfigurable element and the housing while excluding an interior volume of the passive reconfigurable element and an exterior space of the active deformable element. In some embodiments, the substantially sealed space is defined by the active deformable element 200, the passive reconfigurable element 300, the casing 182 and the partition member 116. In some embodiments, the casing 182, a closed end of the support frame 184, an end of the partition member 116 and the passive reconfigurable element 300 collectively define the second pressure chamber 320. Notably, the closed end of the support frame need not be fully enclosed. Rather, in contrast to the opposing open end, this end is fitted with an end baffle configured to constrain air flow. The end baffle substantially overlaps and covers the terminal end of the support frame, and complete fluid-tight sealing is not required; small incidental apertures may be formed therethrough.

In some embodiments, the passive reconfigurable element 300 is a sleeve-like or capsule-like body defining an internal channel configured to receive at least a portion (e.g., penis) of a user’s body. For example, the passive reconfigurable element 300 is a flexible hollow body. In some embodiments, the passive reconfigurable element 300 may be formed from a flexible, resilient, and body-safe material configured to deform repeatedly under pressure variations. For example, the passive reconfigurable element 300 may be formed from silicone elastomer, thermoplastic elastomer (TPE), thermoplastic polyurethane (TPU), rubber-like elastomers, latex-free elastomers, or combinations thereof. The passive reconfigurable element 300 may be an artificial vagina, an artificial oral channel, or other compliant stimulation structure. Specifically, the passive reconfigurable element 300 defines a massage channel dimensioned for accommodation of a penis of a user and the massage channel has an opening configured for the phallic structure to enter and exit the massage channel.

In some embodiments, the opening of the passive reconfigurable element 300 may be configured to be aligned with an upper opening of the housing 10, and may be secured to the device via a mounting ring 196 and/or other sealing structures.

In some embodiments, the sexual stimulation device further includes a cap 178 for covering and protecting the top portion of the flexible hollow body.

In some embodiments, the heating unit and/or a vibrating unit 198 are embedded inside (for example, embedded in the wall of the flexible hollow body) the flexible hollow body.

In some embodiments, the sexual stimulation device includes a one-way valve 150. The one-way valve 150 may be disposed on the partition member 116 to permit airflow only from the first pressure chamber 204 to the second pressure chamber 320 while blocking reverse flow. In some embodiments, the one-way valve 150 may be configured to permit air to be discharged substantially one-way from the enclosed space, for example, the first pressure chamber 204 and/or the second pressure chamber 320, to an ambient environment such that the enclosed space is substantially maintained at a pressure below ambient pressure. In some embodiments, the one-way valve 150 is configured to permit air to be admitted substantially one-way from an ambient environment into the enclosed space such that the enclosed space is substantially maintained at a pressure above ambient pressure.

In operation, the control circuit 140 controls the operation of the motor 112 to generate a desired stimulation pattern. For example, the control circuit 140 may supply drive signals (e.g., PWM signals and/or commutation signals) to a motor driver circuit to start/stop the motor 112 and to control a rotational speed and/or torque of the motor 112 according to a selected mode. The motor 112 rotates under the control of the control circuit 140 and provides rotary output to the thread pair 160 of the transmission mechanism 114. The reciprocating mechanism of the transmission mechanism 114 converts the rotation of the thread pair 160 into a reciprocating motion. The reciprocating mechanism is further operatively coupled to the closed end 204 of the active deformable element 200. When the closed end 204 moves away from the drive mechanism 180, the active deformable element 200 is driven to extend, and the passive reconfigurable element 300 correspondingly stretches; and when the closed end 204 moves toward the drive mechanism 180, the active deformable element 200 is driven to retract, and the passive reconfigurable element 300 correspondingly retracts. In other words, the drive mechanism 180 drives the reciprocating mechanism to lift and lower an upper region (or “top”) of the bellows/bladder portion of the active deformable element 200. As the active deformable element 200 extends and retracts, the effective volume of the first pressure chamber 204 changes, thereby generating a pressure change within the first pressure chamber 204. The pressure change is transmitted through the pressure pathway 120, which provides fluid communication between the second pressure chamber 320 and the first pressure chamber 204, thereby causing a corresponding pressure change in the second pressure chamber 320. In response to the pressure change in the second pressure chamber 320, the passive reconfigurable element 300 reconfigures. For example, when the pressure in the second pressure chamber 320 decreases relative to ambient pressure, the passive reconfigurable element 300 may expand outwardly; and when the pressure in the second pressure chamber 320 increases, the passive reconfigurable element 300 may contract inwardly in an opposite direction. Such repeated deformation of outward expansion and inward contraction of the passive reconfigurable element 300 thereby generate a repeatable pressure cycle that drives cyclic deformation of the passive reconfigurable element 300 to provide suction sexual stimulation.

In other embodiments, the pressure pathway 120 may be arranged to surround at least a portion of the drive mechanism 180, such that the pressure pathway 120 and the drive mechanism 180 are packaged compactly while maintaining fluid communication for pressure transmission.

In some embodiments, an upper planar region of the active deformable element 200 (e.g., a top surface of the bellows/bladder) moves up and down relative to the casing 182 during operation. Such visible movement may provide a visual cue synchronized with the pressure cycle and may create a visual illusion that the flexible hollow body within the casing 182 is reciprocating, thereby enhancing perceived stimulation.

In some embodiments, the sexual stimulation device further includes a first cover 402 configured to cover the second sub-frame 188. The first cover 402 is connected to the first sub-frame 186.

In some embodiments, the sexual stimulation device further includes a second cover 404 configured to cover the active deformable element 200. The second cover 404 is connected to the second sub-frame 188. Specifically, the second cover 404 covering the active deformable element is configured to be translucent such that the movement or the deformation of the active deformable element is visible.

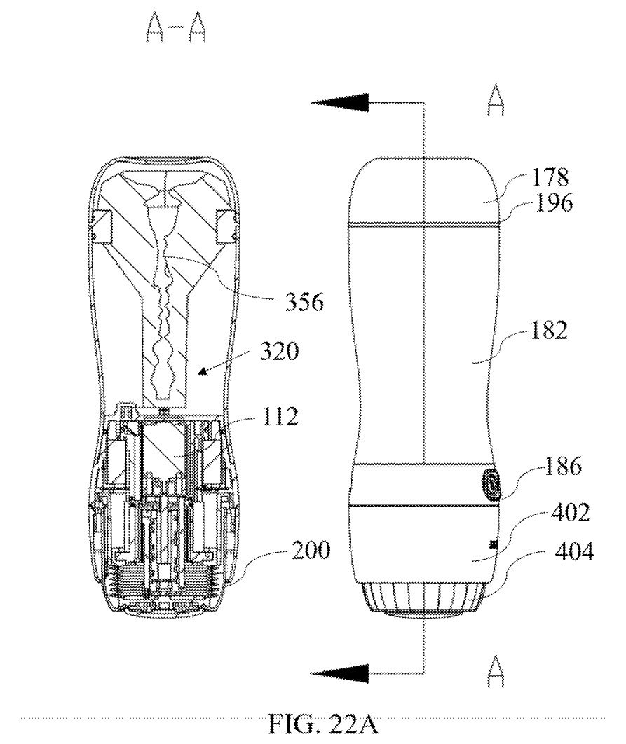

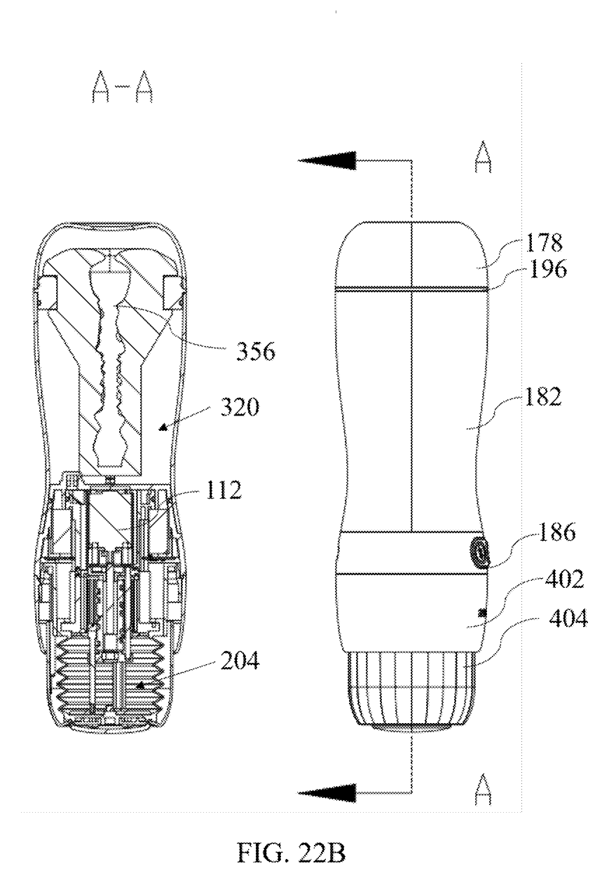

FIG. 22A is a cross-sectional view of a sexual stimulation device in accordance with exemplary embodiments of the present disclosure, with a passive reconfigurable element in a retracted state. FIG. 22B is a cross-sectional view of a sexual stimulation device in accordance with exemplary embodiments of the present disclosure, with a passive reconfigurable element in an extended state.

As shown in FIGS. 22A and 22B, the internal channel and/or an inner surface of the passive reconfigurable element 300 may include one or more stimulation features, such as protrusion structures 356 (e.g., bumps, ribs, grooves, spiral ridges, corrugations, dimples, or textured patterns), which are configured to contact the user’s body and provide frictional and/or compressive stimulation when the passive reconfigurable element 300 deforms and/or undergoes longitudinal displacement.

In some embodiments, the protrusion structures 356 are integrally molded with the passive reconfigurable element 300, while in other embodiments, the protrusion structures 356 are provided as an insert, coating, or replaceable sleeve.

In some embodiments, the sexual stimulation device includes a first guiding mechanism 340, for example, circumferentially arranged guide shafts 341 to guide the deformation of the active deformable element 200. The guide shafts 341 constrain the active deformable element 200 against unregulated radial expansion, lateral deflection and torsional distortion during inflation and deflation, maintain precise coaxial linear telescoping movement, evenly distribute structural stress across all corrugations to avoid localized stress concentration and abnormal wrinkling dislocation, ensure smooth synchronous retraction without jamming or motion hysteresis, stabilize the stress condition of end connecting and sealing interfaces to prevent sealing failure caused by end face warping and eccentric loading, improve the linearity and repeatability of the telescopic stroke for accurate displacement control, and mitigate cyclic fatigue damage induced by repeated inflation-deflation operation to substantially extend the service lifespan of the active deformable element.

In some embodiments, the sexual stimulation device includes a second guiding mechanism configured to constrain lateral deformation of the flexible hollow body. For example, the second guiding mechanism may include one or more guide rods or a sleeve. The guide rods may be arranged around the flexible hollow body, and the sleeve may be sleeved on the flexible hollow body, so that the reconfiguration direction of the flexible hollow body is limited mainly along its longitudinal direction. For example, where inner wall of the sleeve and outer wall of the flexible hollow body are closely spaced, the sleeve radially confines the flexible hollow body to inhibit radial expansion and the flexible hollow body is constrained to reconfigure (e.g., deform and displace) substantially along its axial direction, Such axial movement periodically varies the radial dimension and internal volume of the flexible hollow body, as well as the contact area and contact locations between the penis and the flexible hollow body. Periodic axial reconfigure of the flexible hollow body cyclically compresses and releases the penis accommodated inside the flexible hollow body to generate wrapping extrusion and reciprocating kneading massage on the penis.

The guide rod may be fixed to the support frame 184, specifically, fixed to the second sub-frame 188 and extends along a sidewall of the flexible hollow body. In some embodiments, the guide rod may have an L-like shape. For example, a first leg of the guide rod may be fixed to the casing 182 (e.g., by screws, rivets, clips, snap-fit features, adhesive bonding, or overmolding), and a second leg of the guide rod may extend substantially parallel to the sidewall of the flexible hollow body so as to guide and constrain reconfiguration of the sidewall. In some embodiments, the guide rod includes a single guide rod. In other embodiments, the guide rod includes a plurality of guide rods that are circumferentially distributed around the sidewall, for example, two, three, four, or more guide rods arranged substantially uniformly to provide balanced guidance. The guide rod may be formed from a rigid or semi-rigid material, such as a metal (e.g., stainless steel, aluminum alloy) or a polymer (e.g., POM, nylon, reinforced plastic), and may optionally include a low-friction surface treatment or coating.

In some embodiments, the sleeve includes a low-friction liner or bushing, such as PTFE, UHMWPE, POM, nylon, or a lubricious coating, to reduce wear and improve the smoothness guiding of deformation of the flexible hollow body.

The technical features of the foregoing embodiments may be combined arbitrarily. For brevity of description, not all possible combinations of the technical features of the foregoing embodiments are described. However, the combinations of these technical features should be considered as falling within the scope of this specification provided that there is no contradiction between the combinations.

The foregoing embodiments are merely some specific and detailed embodiments of this application, and description of these embodiments should not be understood as a limitation on the scope of this application. It should be noted that a person of ordinary skill in the art can make any variations and improvements without departing from the concept of this application, and these variations and improvements shall fall within the protection scope of this application. Therefore, the protection scope of this application shall be subject to the appended claims.

1. A sexual stimulation device, comprising:
a housing;
a drive mechanism disposed in the housing;
an active deformable element coupled to the drive mechanism and configured to deform in response thereto to generate a pressure change; and
a passive reconfigurable element configured to stimulate at least part of a sensitive area of a user,
wherein the active deformable element, the passive reconfigurable element, and the housing cooperatively define a substantially sealed space such that deformation of the active deformable element generates the pressure change within the substantially sealed space, and the pressure change is transmitted through the substantially sealed space to thereby passively reconfigure the passive reconfigurable element to provide stimulation to the at least part of the sensitive area.

2. The sexual stimulation device according to claim 1, wherein the sexual stimulation device includes a pressure pathway disposed within the substantially sealed space, and the pressure pathway is configured to transmit the pressure change generated by the active deformable element to the passive reconfigurable element.

3. The sexual stimulation device according to claim 1, wherein the pressure change within the substantially sealed space is dynamically redistributed within the substantially sealed space such that repeated deformation of the active deformable element induces corresponding passive reconfiguration of the passive reconfigurable element to achieve repeatable pressure cycling.

4. The sexual stimulation device according to claim 1, wherein the substantially sealed space includes an interior volume of the active deformable element, a pressure pathway, and a gap space between the passive reconfigurable element and the housing while excluding an interior volume of the passive reconfigurable element and an exterior space of the active deformable element.

5. The sexual stimulation device according to claim 1, wherein the drive mechanism is partially disposed inside the active deformable element and partially disposed between the active deformable element and the passive reconfigurable element.

6. The sexual stimulation device according to claim 5, wherein an end of the drive mechanism is fixedly connected to a closed end of the active deformable element, such that the drive mechanism drives the closed end of the active deformable element toward a motor of the drive mechanism to contract the active deformable element and reduces an inner space thereof, thereby reducing space occupied by the integrated drive mechanism and the active deformable element and facilitating miniaturization thereof.

7. The sexual stimulation device according to claim 1, wherein the drive mechanism includes a motor and a transmission mechanism coupled with the motor.

8. The sexual stimulation device according to claim 7, wherein the transmission mechanism is configured to convert rotary motion of the motor to a reciprocating motion of the active deformable element to control extension and contraction of the active deformable element.

9. The sexual stimulation device according to claim 7, wherein the transmission mechanism includes a thread pair and a sliding and guide assembly, the thread pair includes a screw rod and a movable member movable relative to the screw rod, the guide assembly is configured to guide a linear movement of the movable member.

10. The sexual stimulation device according to claim 7, wherein the motor is disposed between the active deformable element and the passive reconfigurable element.

11. The sexual stimulation device according to claim 7, wherein the active deformable element includes at least one of a bellows, a telescopic sleeve, a telescopic tube, a collapsible elastic bladder and corrugated flexible tube, and a folded wall tube.

12. The sexual stimulation device according to claim 1, wherein at least a part of the active deformable element is configured to undergo visible reciprocating movement to provide a perceptible visual indication corresponding to dynamic changes in sexual stimulation applied by the passive reconfigurable element to the at least part of the sensitive area of the user.

13. The sexual stimulation device according to claim 12, further comprising: a cover covering the active deformable element, wherein the cover is translucent.

14. A sexual stimulation device, comprising:
a housing;
a drive mechanism disposed in the housing;
an active deformable element coupled to the drive mechanism and configured to deform in response thereto to generate a pressure change; and
a passive reconfigurable element configured to stimulate at least part of a sensitive area of a user,
wherein the active deformable element, the passive reconfigurable element, and the housing cooperatively define a substantially sealed space, the pressure change is dynamically redistributed within the substantially sealed space as the pressure change is transmitted through the substantially sealed space to thereby passively reconfigure the passive reconfigurable element.

15. The sexual stimulation device according to claim 14, wherein the substantially sealed space includes a first pressure chamber in the active deformable element, a second pressure chamber between the passive reconfigurable element and the housing, and a pressure pathway configured to transmit the pressure change from the first pressure chamber to the second pressure chamber.

16. The sexual stimulation device according to claim 14, further comprising: a support frame configured to support the drive mechanism.

17. The sexual stimulation device according to claim 15, wherein the sexual stimulation device includes a partition member, and an open end of the active deformable element is joined and sealed with the partition member.

18. The sexual stimulation device according to claim 17, wherein the pressure pathway extends through the partition member to provide fluid communication between the first pressure chamber and the second pressure chamber.

19. The sexual stimulation device according to claim 14, wherein the drive mechanism comprises a motor and a transmission mechanism coupled with the motor, and the transmission mechanism is configured to convert rotary motion of the motor into reciprocating linear movement of the active deformable element, thereby causing repeatedly stretching and retracting of the at least a portion of the active deformable element.

20. The sexual stimulation device according to claim 14, wherein the drive mechanism comprises a motor and a transmission mechanism coupled with the motor, the motor is disposed between the active deformable element and the passive reconfigurable element, and the transmission mechanism is partially disposed inside the active deformable element, thereby reducing space occupied by the integrated drive mechanism and the active deformable element and facilitating miniaturization thereof.
